(19) United States
(12) Patent Application Publication
(10) Pub. No.: US 2024/0236655 A1
(43) Pub. Date: Jul. 11, 2024

(54) INFORMATION INDICATION METHOD, FIRST ACCESS NETWORK DEVICE, AND CORE NETWORK ELEMENT

(71) Applicant: GUANGDONG OPPO MOBILE TELECOMMUNICATIONS CORP., LTD., Dongguan (CN)

(72) Inventor: Yali GUO, Dongguan (CN)

(21) Appl. No.: 18/615,139

(22) Filed: Mar. 25, 2024

Related U.S. Application Data
(63) Continuation of application No. PCT/CN2021/121469, filed on Sep. 28, 2021.

(51) Int. Cl. H04W 8/24

(52) U.S. Cl. CPC H04W 8/24

(57) ABSTRACT

Provided are an access network device, a core network device, and a terminal. The access network device includes a transceiver, which is configured to transmit first indication information to a core network element, where the first indication information is used for indicating a sensing capability of the access network device.

### CROSS-REFERENCE TO RELATED APPLCIATION

This is a continuation application of International Patent Application No. PCT/CN2021/121469 filed on Sep. 28, 2021, the content of which is hereby incorporated by reference in its entirety.

### BACKGROUND

Because the current cellular network is widely used for communication, both terminals and access network devices naturally support a communication capability. However, the cellular network will be used not only for the communication, but also for sensing of the environment near the access network devices or the terminals. There are various sensing types, such as environmental imaging, weather monitoring, breath and gesture recognition of terminal users, and measurement of terminal moving speed, etc.

However, different communication devices, such as different access network devices and different terminals, etc., may only support specific sensing types. Therefore, when a specific access network device or terminal is required to perform certain types of sensing, a correct sensing result cannot be obtained due to different capabilities of the access network device or the terminal.

### SUMMARY

The present disclosure relates to the field of communications.

In view of this, embodiments of the present disclosure provide a method for information indication, a first access network device and a core network element, which can be used in sensing capability interaction.

An embodiment of the present disclosure provides a first access network device, including a transceiver. The transceiver is configured to transmit first indication information to a second access network device and/or a core network element, and the first indication information is used for indicating a sensing capability of the first access network device.

An embodiment of the present disclosure provides a core network element, including a transceiver. The transceiver is configured to transmit first indication information to an access network device, and the first indication information is used for indicating a sensing capability of the core network element.

An embodiment of the present disclosure provides a first terminal, including a transceiver. The transceiver is configured to transmit first indication information to a first core network element, and the first indication information is used for indicating a sensing capability of the first terminal and/or sensing grant information for the first terminal.

Based on the technical solutions of the embodiments of the present disclosure, the electronic equipment can interact with each other on their respective sensing capabilities, the sensing capability of a terminal, the sensing grant information for the terminal, and the like. Thus, the electronic equipment such as the access network device or the core network element can indicate or request a corresponding device(s) to start the sensing function according to actual requirements, and obtain an accurate sensing result.

### BRIEF DESCRIPTION OF THE DRAWINGS

FIG. 1 is a schematic diagram of a communication system architecture according to an embodiment of the present disclosure.

FIG. 2 is a schematic diagram of a 5G network system architecture according to an embodiment of the present disclosure.

FIG. 3 is a schematic flowchart of a method for information indication according to a first embodiment of the present disclosure.

FIG. 4 is a schematic flowchart of a method for information indication according to a second embodiment of the present disclosure.

FIG. 5 is a schematic flowchart of a method for information indication according to a third embodiment of the present disclosure.

FIG. 6 is a schematic flowchart of a method for information indication according to a fourth embodiment of the present disclosure.

FIG. 7 is a flowchart of a control plane applying a first example of the present disclosure.

FIG. 8 is a flowchart of a control plane applying a second example of the present disclosure.

FIG. 9 is a schematic flowchart of a method for information indication according to a fifth embodiment of the present disclosure.

FIG. 10 is a schematic flowchart of a method for information indication according to a sixth embodiment of the present disclosure.

FIG. 11 is a schematic flowchart of a method for information indication according to a seventh embodiment of the present disclosure.

FIG. 12 is a schematic flowchart of a method for information indication according to an eighth embodiment of the present disclosure.

FIG. 13 is a flowchart of a control plane applying a third example of the present disclosure.

FIG. 14 is a flowchart of a control plane applying a fourth example of the present disclosure.

FIG. 15 is a schematic block diagram of a first access network device 100 according to an embodiment of the present disclosure.

FIG. 16 is a schematic block diagram of an access network device 200 according to an embodiment of the present disclosure.

FIG. 17 is a schematic block diagram of a core network element 300 according to an embodiment of the present disclosure.

FIG. 18 is a schematic block diagram of a first core network element 400 according to an embodiment of the present disclosure.

FIG. 19 is a schematic block diagram of a first terminal 500 according to an embodiment of the present disclosure.

FIG. 20 is a schematic block diagram of a second core network element 600 according to an embodiment of the present disclosure.

FIG. 21 is a schematic block diagram of first electronic equipment 700 according to an embodiment of the present disclosure.

FIG. 22 is a schematic block diagram of second electronic equipment 800 according to an embodiment of the present disclosure.

FIG. 23 is a schematic block diagram of a communication device according to an embodiment of the present disclosure.

FIG. 24 is a schematic block diagram of a chip according to an embodiment of the present disclosure.

FIG. 25 is a schematic block diagram of a communication system according to an embodiment of the present disclosure.

### DETAILED DESCRIPTION

The technical solution in embodiments of the present disclosure will be described below in combination with the drawings in the embodiments of the present disclosure.

It should be understood that terms “system” and “network” in the present disclosure may usually be exchanged. In the present disclosure, the term “and/or” is only used for describing an association relationship of associated objects, for example, the term “and/or” represents that three relationships may exist between previous and next associated objects. For example, A and/or B may represent three conditions: independent existence of A, existence of both A and B, and independent existence of B. Character “/” in the present disclosure usually represents that an “or” relationship is formed between the previous and next associated objects.

It should be understood that the “indication” mentioned in the embodiments of the present disclosure may be a direct indication, may be an indirect indication, or may represent an association relationship. For example, A indicating B may represent that A directly indicates B, e.g., B can be obtained through A, may also represent that A indirectly indicates B, e.g., A indicates C, and B can be obtained through C, or may also represent that there is an association relationship between A and B.

In the description of the embodiments of the disclosure, the term “corresponding to” may represent that there is a direct correspondence or an indirect correspondence relationship between two elements, may also represent that there is an association relationship between the two elements, or may also be a relationship of indicating and being indicated, or configuration and being configured, etc.

The technical solution in embodiments of the present disclosure can be applied to various communication systems, such as a Global System of Mobile communication (GSM) system, a Code Division Multiple Access (CDMA) system, a Wideband Code Division Multiple Access (WCDMA) system, a General Packet Radio Service (GPRS) system, a Long Term Evolution (LTE) system, an Advanced Long Term Evolution (LTE-A) system, a New Radio (NR) system, an evolution system of the NR system, a LTE-based access to unlicensed spectrum (LTE-U) system, a NR-based access to unlicensed spectrum (NR-U) system, a Non-Terrestrial Network (NTN) system, a Universal Mobile Telecommunications System (UMTS), a Wireless Local Area Network (WLAN), a Wireless Fidelity (WiFi), a 5th Generation (5G) system or other communication systems.

In general, traditional communication systems support a limited number of connections and are easy to implement. However, with the development of the communication technologies, mobile communication systems will not only support traditional communication, but also support, for example, Device to Device (D2D) communication, Machine to Machine (M2M) communication, Machine Type Communication (MTC), Vehicle to Vehicle (V2V) communication, or Vehicle to everything (V2X) etc. The embodiments of the present disclosure can also be applied to these communication systems.

Alternatively, the communication systems in the embodiments of the present disclosure may be applied to Carrier Aggregation (CA) scenarios, Dual Connectivity (DC) scenarios, or Standalone (SA) network deployment scenarios.

Each embodiment is described in connection with an access network device and a terminal device in the embodiments of the present disclosure. The terminal device may also be referred to as a User Equipment (UE), an access terminal, a user unit, a user station, a mobile station, a remote station, a remote terminal, a mobile device, a user terminal, a terminal, a wireless communication device, a user agent or a user apparatus, etc.

The terminal device may be a station (ST) in the WLAN, a cellular telephone, a cordless telephone, a Session Initiation Protocol (SIP) telephone, a Wireless Local Loop (WLL) station, a Personal Digital Processing (PDA) device, a handheld device having a wireless communication function, a computing device or other processing devices connected to a wireless modem, an on-board equipment, a wearable device, a next generation communication system, such as a terminal device in an NR network, or a terminal device in a future evolved Public Land Mobile Network (PLMN), etc.

In the embodiments of the present disclosure, the terminal device may be arranged on land including indoor or outdoor areas, handheld, wearable or on-board. The terminal device may also be arranged on the water (such as on a ship). The terminal device may further be arranged in the air (such as on an airplane, a balloon, or a satellite).

In the embodiments of the present disclosure, the terminal device may be a mobile phone, a tablet computer (or Pad), a computer with wireless transceiver function, a Virtual Reality (VR) terminal device, an Augmented Reality (AR) terminal device, a wireless terminal device in industrial control, a wireless terminal device in self driving, a wireless terminal device in remote medical, a wireless terminal device in a smart grid, a wireless terminal device in transportation safety, a wireless terminal device in a smart city, or a wireless terminal equipment in a smart home, etc.

As an example rather than a limitation, in the embodiments of the present disclosure, the terminal device may also be a wearable device. The wearable device may also be referred to as a wearable intelligent device, which is a general name of the wearable devices developed by intelligently designing for the daily wears with a wearable technology, such as glasses, gloves, watches, clothing and shoes. The wearable device is a portable device that is worn directly on the body or integrated into the user's clothes or accessories. The wearable device is not only a hardware device, but also a device realizing powerful functions through software support, data interaction and cloud interaction. Generalized wearable intelligent devices include: a device (such as intelligent watches or intelligent glasses) with full functions and large size, which can implement complete or partial functions without relying on an intelligent phone, and a device (such as various intelligent bracelets and intelligent jewelries for monitoring physical signs) which only focuses on a certain application function, and is used in conjunction with other devices (such as smart phone).

In the embodiments of the present disclosure, the access network device may be a device for communicating with a mobile device, and the access network device may be an Access Point (AP) in the WLAN, a Base Transceiver Station (BTS) in the GSM or CDMA, a NodeB (NB) in the WCDMA, an Evolutional Node B (eNB or eNodeB) in the LTE, a relay station or an AP, an on-board equipment or a wearable device, an access network device or gNB in an NR network or an access network device in a future evolved PLMN network.

As an example rather than a limitation, in the embodiments of the present disclosure, the access network device may have mobility, for example, the access network device may be a mobile device. Optionally, the network device may be a satellite or a balloon station. For example, the satellite may be a Low Earth Orbit (LEO) satellite, a Medium Earth Orbit (MEO) satellite, a Geostationary Earth Orbit (GEO) satellite, a High Elliptical Orbit (HEO) satellite, or the like. Optionally, the access network device may also be a base station arranged on land, on the water and the like.

In the embodiments of the present disclosure, the network device may provide services for a cell, and the terminal device communicates with the access network device through the transmission resources (such as frequency domain resources, also called spectrum resources) used by the cell. The cell may be a cell corresponding to the access network device (e.g., the base station), and the cell may belong to a macro base station or a base station corresponding to a small cell. The small cell may include a metro cell, a micro cell, a pico cell, a femto cell, etc. These small cells have characteristics of small coverage and low transmission power, which are suitable for providing services of high-speed data transmission.

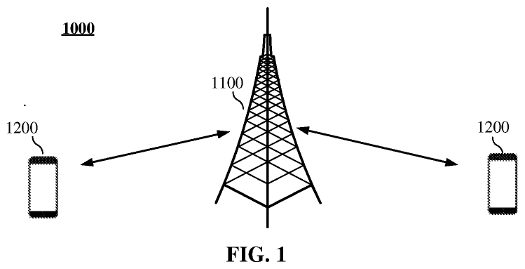

FIG. 1 schematically illustrates a wireless communication system 1000 including one access network device 1100 and two terminal devices 1200. Optionally, the wireless communication system 1000 mayinclude a plurality of access network devices 1100, and other numbers of terminal devices may be included within the coverage area of each access network device 1100, which is not limited in embodiments of the present disclosure.

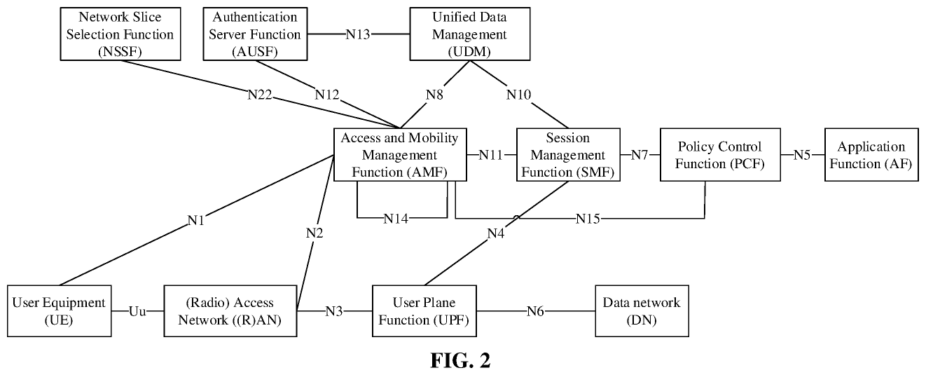

Optionally, the wireless communication system further includes a core network for communicating with the access network device. Exemplarily, FIG. 2 illustrates a schematic diagram of a 5G network system architecture, where the 5G network includes a UE and a (Radio) Access Network ((R) AN) device, and further includes a Data Network (DN) and a plurality of core network elements:
Network Slice Selection Function (NSSF);
Authentication Server Function (AUSF);
Unified Data Management (UDM);
Access and Mobility Management Function (AMF);
Session Management Function (SMF);
Policy Control Function (PCF);
Application Function (AF);
User Plane Function (UPF).

The UE performs an access stratum connection, interacts access layer messages and performs wireless data transmissions with the AN through a Uu interface. The UE performs a Non Access Stratum (NAS) connection and interacts NAS messages with the AMF through a N1 interface. The AMF is a mobility management function in the core network, the SMF is a session management function in the core network, and the AMF is responsible for forwarding session management related messages between the UE and the SMF in addition to performing the mobility management on the UE. The PCF is a policy management function in the core network, and the PCF is responsible for formulating policies related to the mobility management, the session management, charging and so on for the UE. The UPF is a user plane function in the core network, and the UPF performs data transmission with an external data network through a N6 interface and performs data transmission with the AN through a N3 interface.

It should be understood that a device having a communication function in the network/system in embodiments of the present disclosure may be referred to as a communication device. The communication system shown in FIG. 1 is taken as an example, the communication device may include an access network device and a terminal device(s) having the communication function, where the access network device and the terminal device may be specific devices in the embodiments of the present disclosure, and will not be elaborated herein. The network system architecture shown in FIG. 2 is taken as an example, and the communication device may further include other devices in the communication system, such as a data management network element, a mobility management network element and other core network elements, which are not limited in the embodiments of the present disclosure.

The current cellular network, including the 5G network, is mainly used for the communication. However, the wireless electromagnetic signals used by the cellular network can not only be used for the wireless data transmission and communication, but also have environment sensing capabilities, such as the motion or gesture recognition, the speed measurement, the imaging and so on. Therefore, future cellular networks may be considered not only for the communication and data transmission, but also for the acquisition of sensing information.

If the future cellular networks are not only used for the communication, but also for sensing of the environment near the access network device or the terminal, due to the various sensing types, such as the environmental imaging, the weather monitoring, the breath recognition and gesture recognition for the terminal users, and the measurement of the terminal moving speed, etc., different access network devices and different terminals may only support specific sensing types, and thus when a specific access network device or terminal is required to perform certain types of sensing, a correct sensing, result may not be obtained due to different capabilities of the access network device or the terminal. At the same time, it should be considered that the sensing, involves users' privacy, and it may violate the users' privacy right if the cellular network performs sensing of users without authorization.

The solution provided by the embodiments of the present disclosure is mainly used for solving at least one of the above problems.

In order to enable a more detailed understanding of the features and technical contents of the embodiments of the present disclosure, the implementations of the embodiments of the present disclosure will be described in detail below in conjunction with the accompanying drawings. The accompanying drawings are provided for illustration only and are not intended to limit the embodiments of the present disclosure.

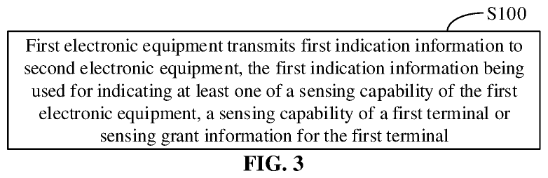

FIG. 3 is a schematic flowchart of a method for information indication according to an embodiment of the present disclosure. The method optionally may be applied to the systems shown in FIG. 1 and FIG. 2, but is not limited thereto. The method includes following operation S100.

At S100, first electronic equipment transmits first indication information to second electronic equipment, and the first indication information is used for indicating at least one of a sensing capability of the first electronic equipment, a sensing capability of a first terminal or sensing grant information for the first terminal.

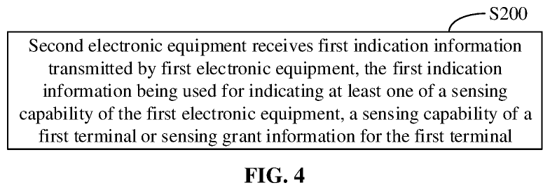

Accordingly, the embodiments of the present disclosure further provides a method for information indication as shown in FIG. 4, the method includes following operation S200.

At S200, second electronic equipment receives first indication information transmitted by first electronic equipment, and the first indication information is used for indicating at least one of a sensing capability of the first electronic equipment, a sensing capability of a first terminal and sensing grant information for the first terminal.

It can be seen that the electronic equipment can interact with each other on their respective sensing capabilities, the sensing capability of a specific terminal, the sensing grant information for the specific terminal, and other sensing related information.

Optionally, the sensing capability includes whether to support sensing and/or a sensing type supported. Exemplarily, the sensing types include environmental imaging, the weather monitoring, the breath recognition and gesture recognition for the terminal users, and the measurement of the terminal moving speed, etc.

Optionally, the sensing grant information for the first terminal is used to represent whether sensing of the first terminal is allowed.

Optionally, the first electronic equipment includes at least one of an access network device, a core network element or a terminal.

Optionally, the second electronic equipment includes at least one of an access network device or a core network element.

For example, the second electronic equipment may be an access network device and the first electronic equipment may include another access network device, a core network element, etc. The access network device as an information receiver may receive the indication information from the another access network device or the core network element, and obtain the sensing capability of an information transmitter. The access network device may also receive the indication information from the core network element, and obtain the sensing capability of a specific terminal, the sensing grant information for the specific terminal, and the like. In such a manner, the access network device may indicate (or request) another access network device or terminal to initiate the sensing capability according to the sensing capability of another core network, the sensing capability of the terminal, or the sensing grant information for the terminal. The access network device may also select an appropriate core network element for the UE according to the sensing capability of the core network element.

For another example, the second electronic equipment is a core network element, and the first electronic equipment may include an access network device, another core network element, a terminal, etc. The core network element as an information receiver may receive the indication information from the access network device or the terminal, and obtain the sensing capability of an information transmitter. The core network element may also receive the indication information from the another core network element, and obtain the sensing capability of a specific terminal, the sensing grant information for the specific terminal, etc. In such a manner, the core network element may indicate (or request) the access network device or the terminal to start the sensing capability according to the sensing capability of the access network device, or the sensing capability of the terminal, or the sensing grant information for the terminal.

It can be seen that according to the above method, the electronic equipment such as the access network device or the core network element can indicate or request the corresponding device to start the sensing function according to actual requirements, and obtain an accurate sensing result.

The above methods will be described in detail for specific devices.

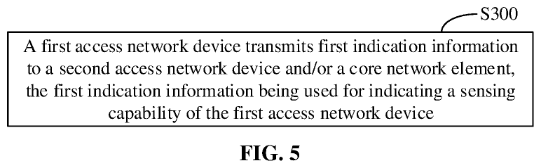

For the access network device, which can be regarded as the information receiver, it can actively transmit its own sensing capability to another device(s). Specifically, FIG. 5 illustrates a method for information indication provided by an embodiment of the present disclosure, and the method may include following operation S300.

At S300, a first access network device transmits first indication information to a second access network device and/or a core network element, and the first indication information is used for indicating a sensing capability of the first access network device.

Optionally, the sensing capability includes whether to support sensing and/or a sensing type(s) supported.

Optionally, the first indication information is carried by an access network device setup message or an access network device configuration update message. For example, the first access network device may transmit the access network device setup message carrying the above indication information to the second access network device or the core network element when the first access network device is started. For another example, the first access network device may transmit the access network device configuration update message carry the above indication information to the second access network device or the core network element when the configuration of the first access network device is updated.

Optionally, after the first indication information is transmitted, the first access network device may receive response information. That is, the above method further include following operation.

The first access network device receives first response information for the first indication information from the second access network device and/or the core network element.

Optionally, the first response information is further used for indicating a sensing capability of the second access network device and/or a sensing capability of the core network element.

Optionally, the access network device may be regarded as the information receiver to receive a sensing capability of another device transmitted from the another device. The method for information indication provided by an embodiment of the present disclosure may include following operation.

The first access network device receives second indication information from the second access network device and/or the core network element, and the second indication information is used for indicating a sensing capability of the second access network device and/or the core network element.

Optionally, the second indication information is carried by an access network device setup message, an access network device configuration update message or a core network configuration update message. For example, the second indication information is from the second access network device, and the second indication information may be carried and transmitted by the access network device setup message or the access network device configuration update message when the second access network device is started or when the configuration of the second access network device is updated. For another example, the second indication information is from the core network element, and the second indication information the core network element is updated.

Optionally, after the second indication information is received, the first access network device may transmit response information. That is, the above method further includes following operation.

The first access network device transmits a second response message for the second indication information to the second access network device and/or the core network element.

Optionally, the second response message is further used for indicating the sensing capability of the first access network device.

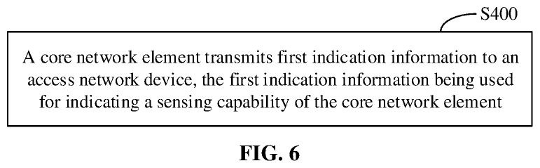

Corresponding to the above method, for the core network element, it may also transmit its own sensing capability to the access network device. An embodiment of the present disclosure further provides a method for information indication, and as shown in FIG. 6, the method includes following operation S400.

At S400, a core network element transmits first indication information to an access network device, and the first indication information is used for indicating a sensing capability of the core network element.

Optionally, the first indication information is carried by a core network configuration update message. For example, the core network element may transmit the first indication information carrying the above indication information to the access network device when the configuration of the core network element is updated.

Optionally, after the first indication information is transmitted, the core network element may receive corresponding response information. That is, the above method further include following operation.

The core network element receives first response information for the first indication information from the access network device.

Optionally, the first response information is further used for indicating a sensing capability of the access network device.

Optionally, the core network element may also receive a sensing capability of the access network device transmitted by the access network device. That is, the method may further include following operation.

The core network element receives second indication information from the access network device, and the second indication information is used for indicating a sensing capability of the access network device.

Optionally, after the second indication information is received, the core network element may transmit response information. That is, the method may further include following operation.

The core network element transmits second response information for the second indication information to the access network device.

Optionally, the second response information is further used for indicating the sensing capability of the core network element.

Optionally, in each of the above optional manners, the core network element may include a mobility management network element, such as the AMF.

Specific application examples of the above information indication method for a sensing capability interaction between an access network device and another access network device or between an access network device and a core network element will be provided below in conjunction with the drawings.

### First Application Example

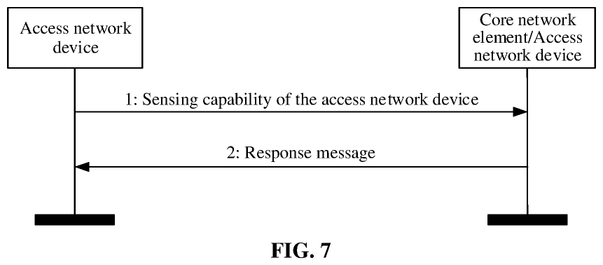

FIG. 7 illustrates a flowchart of a control plane of the present application example. The flow is a device-level flow, that is, a device-level parameter interaction between the access network device and the core network element or another access network device, rather than a UE-level parameter interaction.

As shown in FIG. 7, the method for information indication includes following operations.

At operation 1, the access network device transmits indication information to the core network element/another access network device to indicate a sensing capability of the access network device. The core network element here is for example a mobility management network element located in the core network, such as the AMF in an example of the 5G network shown in FIG. 2, but is not limited thereto.

The sensing capability for example includes:
whether to support sensing capability;
a type(s) of sensing capability supported.

When the receiver is a core network element, the message carrying the indication information is, for example, a NG SETUP REQUEST message or a RAN CONFIGURATION UPDATE message in the 5G network, but is not limited thereto.

When the receiver is another access network device, the message carrying the indication information is, for example, an XN SETUP REQUEST message or a NG-RAN NODE CONFIGURATION UPDATE message in the 5G network, but is not limited thereto.

At operation 2, the core network element/another access network device receiving the indication information transmits a response message. The response message may be a simple response message. Optionally, the response message may also carry the sensing capability of the receiver.

When the receiver is the core network element, the response message is, for example, a NG SETUP RESPONSE message or a RAN CONFIGURATION UPDATE ACKNOWLEDGE message in the 5G network, but is not limited thereto.

When the receiver is another access network device, the response message is, for example, an XN SETUP RESPONSE message or a NG-RAN NODE CONFIGURATION UPDATE ACKNOWLEDGE message in the 5G network, but is not limited thereto.

### Second Application Example

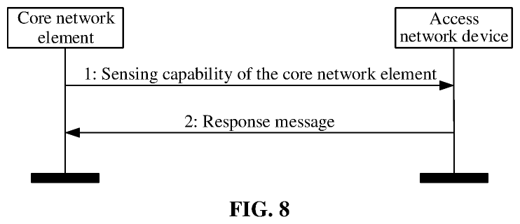

FIG. 8 illustrates a flowchart of a control plane of the present application example. The flow is a device-level flow, that is, a device-level parameter interaction between the access network device and the core network element or another access network device, rather than a UE-level parameter interaction.

As shown in FIG. 8, the method for information indication includes following operations.

At operation 1, the core network element transmits indication information to the access network device to indicate the sensing capability of the core network element. The core network element here is for example a mobility management network element located in the core network, such as the AMF in an example of the 5G network shown in FIG. 2. A message carrying the indication is for example an AMF CONFIGURATION UPDATE message in the 5G network, but is not limited thereto.

At operation 2, the access network device transmits a response message to the core network element. The response message may be a single response message. Optionally, the response message may also carry the sensing capability of the receiver. The response message for example is an AMF CONFIGURATION UPDATE ACKNOWLEDGE message in the 5G network, but is not limited thereto.

Through the above application examples, it can be seen that their respective sensing capabilities are interacted between the access network devices or between the access network device and the core network element.

Therefore, the core network element may according to the sensing capability of the access network device, indicate (or request) the access network device to start the sensing function or start a specific type of sensing function, such as starting the monitoring of local weather conditions, etc.

An access network device may also, according to the sensing capability of the other access network device, indicate (or request) the other access network device to start the sensing function or start a specific type of sensing function.

The access network device may select an appropriate core network element for the UE according to the sensing capability of the core network element. For example, according to a request message including sensing related information obtained from the UE and the sensing capability of the core network element, the access network device selects the appropriate core network element to serve the UE.

On the other hand, the core network element may also obtain a sensing capability of the UE or obtain a grant of whether sensing of the UE is allowed.

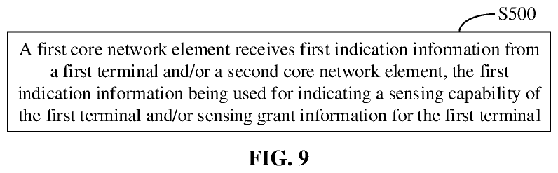

FIG. 9 illustrates a method for information indication according to an embodiment of the present disclosure. As shown in FIG. 9, the method includes following operation S500.

At S500, a first core network element receives first indication information from a first terminal and/or a second core network element, and the first indication information is used for indicating a sensing capability of the first terminal and/or sensing grant information for the first terminal.

Optionally, the sensing capability includes whether to support sensing and/or a sensing type supported.

Optionally, the sensing grant information for the first terminal is used to indicate whether sensing of the first terminal is allowed.

In an exemplary implementation, the first core network element may receive indication information from the first terminal, and the indication information indicates the sensing capability of the first terminal and/or the sensing grant information for the first terminal.

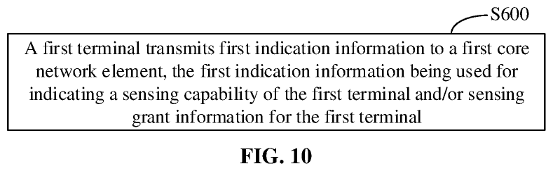

Accordingly, each of terminals may transmit indication information to the core network element to indicate its own sensing capability and/or sensing grant information. An embodiment of the present disclosure further provides a method for information indication, and as shown in FIG. 10, the method includes following operation S600.

At S600, a first terminal transmits first indication information to a first core network element, and the first indication information is used for indicating a sensing capability of the first terminal and/or sensing grant information for the first terminal.

Optionally, the first indication information is carried by a terminal registration request message. For example, during registration, the first terminal transmits the terminal registration request message carrying the indication information to the core network element.

In another exemplary implementation, the first core network element may receive indication information from another core network element (second core network element). The indication information indicates sensing grant information for the first terminal, and the sensing grant information may be pre-stored in the second core network element.

Optionally, the second core network element includes a data management network element and/or a data storage network element.

Exemplary, the data management network element or the data storage network element may be used to store sensing capabilities of the respective terminals and/or the sensing grant information for the respective terminals received by the data management network element or the data storage network element, the data management network element or the data storage network element is for example the UDM shown in FIG. 2. Exemplary, the sensing grant information for the terminal may be pre-stored in the data management network element and/or the data storage network element in a certain manner, for example, the sensing grant information subscribed by the terminal is obtained in a subscription between the terminal and the core network, and the sensing grant information is stored in the data management network element and/or the data storage network element. Therefore, there is no need for the terminal to initiate an indication of the sensing grant information to the core network actively.

Optionally, after the first core network element obtains the sensing capability of the first terminal and/or the sensing grant information for the first terminal, the first core network element may transmit the above information to another core network element, an access network device. That is, the method for information indication may include following operation.

The first core network element transmits second indication information to an access network device and/or a third core network element, and the second indication information is used for indicating the sensing capability of the first terminal and/or the sensing grant information for the first terminal.

Optionally, the second indication information transmitted to the access network device is carried by a terminal context.

Optionally, the third core network element includes at least one of a sensing control network element, a data management network element or a data storage network element.

For example, in a case that the first core network element receives the indication information from the first terminal, the third core network element may include one or more of the sensing control network element, the data management network element, and the data storage network element. The first core network element determines the sensing capability of the first terminal and/or the sensing grant information for the first terminal based on the received indication information, and accordingly transmits the indication information to one or more of the access network device, the sensing control network element, the data management network element and the data storage network element to indicate the sensing capability and/or the sensing grant information of the first terminal.

For another example, in a case that the first core network element receives the indication information from the second core network element (a data management network element or a data storage network element), the third core network element may include the sensing control network element. The sensing control network element is a network element specially used for the sensing control in the core network. The first core network element determines the sensing grant information for the first terminal based on the received indication information, and may transmit the indication information to the access network device and/or the sensing control network element accordingly to indicate the sensing grant information for the first terminal.

Optionally, in the above method, the first core network element may include a mobility management network element, such as the AMF.

Optionally, the first core network element may also include the sensing control network element, and the second core network element may include at least one of the mobility management network element, the data management network element, and the data storage network element. The mobility management network element, the data management network element and the data storage network element may transmit the received or pre-stored sensing capability of the terminal and/or sensing grant information for the terminal to the sensing control network element.

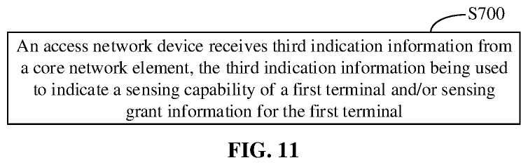

Corresponding to the method described above, the access network device may receive the sensing capability of a specific terminal, such as the first terminal, and/or the sensing grant information for the first terminal. Specifically, an embodiment of the present disclosure further provides a method for information indication, and as shown in FIG. 11, the method includes following operation S700.

At S700, the access network device receives third indication information from the core network element, and the third indication information is used to indicate the sensing capability of the first terminal and/or the sensing grant information for the first terminal.

Optionally, the core network element includes the mobility management network element.

Optionally, the third indication information is carried by a terminal context.

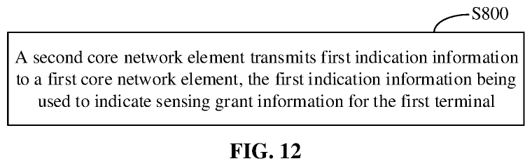

Corresponding to the above method, the second core network element in the core network may transmit first indication information to the first core network element to indicate sensing grant information for the terminal. Exemplary, as shown in FIG. 12, the method may include following operation S800.

At S800, the second core network element transmits first indication information to the first core network element, and the first indication information is used to indicate sensing grant information for the first terminal.

Optionally, the sensing grant information is pre-stored in the second core network element.

For example, the second core network element includes the data management network element and/or the data storage network element, such as the UDM shown in FIG. 2. The data management network element and/or the data storage network element obtain and stores the sensing grant information for the terminal based on the subscription-related information between the terminal and the core network.

Optionally, the first core network element includes the sensing control network element.

Optionally, the first core network element includes the mobility management network element, such as the AMF.

The second core network element may transmit its pre-stored sensing grant information for the first terminal to the mobility management network element. Optionally, for other terminals, the second core network element may also obtain sensing grant information for the other terminals and/or sensing capabilities of the other terminals from the mobility management network element. That is, the method for information indication may further include following operation.

The second core network element receives second indication information from the mobility management network element, and the second indication information is used to indicate sensing capability of the second terminal and/or sensing grant information for the second terminal.

A specific application example of the above-described information indication method used for exchanging the sensing capability of the terminal and/or the sensing grant information for the terminal will be provided below in conjunction with the drawings.

### Third Application Example

The application example is used for the core network element or the access network device to obtain a sensing capability of UE, or to obtain a grant of whether sensing of a specific UE is allowed.

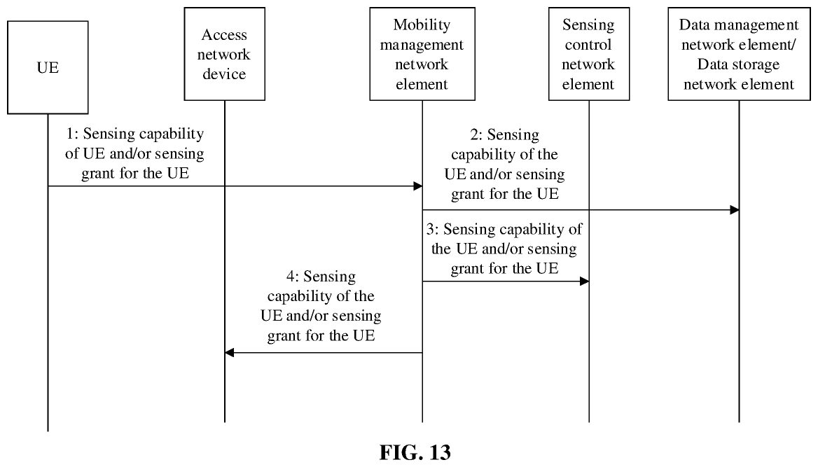

FIG. 13 is a flowchart of a control plane of the present application example. The flow is a UE-level flowchart, where a UE-level parameter interaction is performed.

As shown in FIG. 13, the method for information indication includes following operations.

At operation 1, UE transmits indication information to a mobility management network element to indicate a sensing capability of the UE and sensing grant information for the UE.

The sensing capability for example includes:
whether to support sensing capability;
types of sensing capability supported.

The sensing grant information for the UE is used to represent whether the UE allows the network to start the sensing of the UE.

The message carrying the indication information is for example a Registration Request message in the 5G network, but is not limited thereto.

At operation 2, the mobility management network element may store the received sensing capability of the UE and/or the sensing grant information for the UE in the data management network element or the data storage network element of the core network, for example, the data management network element or the data storage network element is the UDM network element, the UDR network element or the UDSF network element in the 5G network. Subsequently, the mobility management network element or another core network element obtains the sensing capability of the UE and/or the sensing grant for the UE from the data management network element or the data storage network element.

At operation 3, the mobility management network element may transmit the received sensing capability of the UE and/or the sensing grant information for the UE to the sensing control network element (a network element specially performing the sensing control), for the sensing control network element subsequently determining whether to start the sensing of the UE.

At operation 4, the mobility management network element may store the received sensing capability of the UE and/or the sensing grant information for the UE into a UE context and transmit it to the access network device, for the access network device to subsequently determine whether to start the sensing of the UE.

It should be noted that the above operations 2, 3 and 4 are optional rather than necessary operations, and there is no timing sequence.

By implementing the method of the application example, the access network device, the mobility management network element, and the sensing control network element have obtained the sensing capability of a specific UE and/or the sensing grant for the UE. Therefore, the sensing capability of the UE and/or the sensing grant for the UE can be considered in the subsequent determination of whether to start the sensing of the UE, so that the sensing of the UE is supported by the UE and agreed by the UE.

### Fourth Application Example

The present application example is another manner for the core network element or the access network device to obtain sensing grant information for the specific UE.

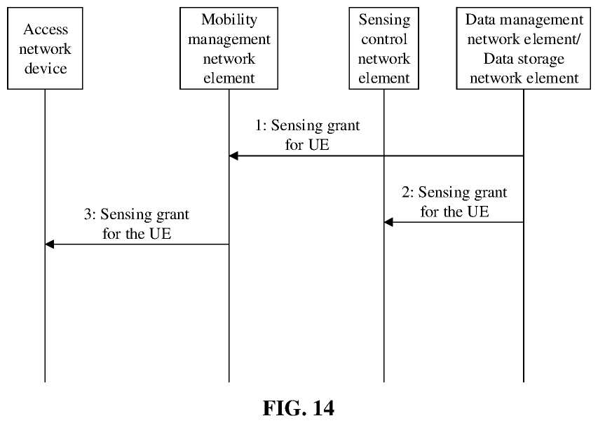

FIG. 14 is a flowchart of a control plane of the present application example. The flow is a UE-level flowchart, where a UE-level parameter interaction is performed.

The sensing grant information for the UE in the application example is considered to be pre-stored in a core network database through a certain manner, for example, based on a subscription between the UE and the core network. That is to say, the sensing grant information for the UE has been stored in the core network database without need of using a manner of network signaling interaction. Therefore, the method may include following operations.

At operation 1, the data management network element or the data storage network element in the core network transmits the sensing grant information for the UE to the mobility management network element.

At operation 2, the data management network element or the data storage network element in the core network transmits the sensing grant information for the UE to the sensing control network element.

Optionally, in operation 1 and operation 2, the data management network element or the data storage network element may transmit the sensing grant information for the UE actively or according to the request of the mobility management network element or the sensing control network element.

The method may further include an operation 3.

At operation 3, the mobility management network element may store the received sensing grant for the UE into the UE context and transmit it to the access network device, for the access network device to subsequently determine whether to start the sensing of the UE.

The specific arrangement and implementation of the embodiments of the present disclosure have been described above from different angles through a plurality of embodiments. With at least one of the above embodiments, the access network device or the core network element can indicate or request a corresponding device to start the sensing function according to actual requirements, so that the sensing is supported and agreed by the device, thereby obtaining an accurate sensing result.

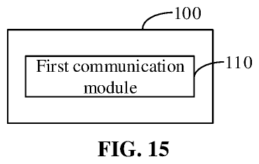

Corresponding to the processing method of at least one embodiment described above, an embodiment of the present disclosure further provides a first access network device 100. Referring to FIG. 15, the first access network device 100 includes a first communication module 110.

The first communication module 110 is configured to transmit first indication information to a second access network device and/or a core network element, and the first indication information is used for indicating a sensing capability of the first access network device.

Optionally, the sensing capability includes whether to support sensing and/or a sensing type supported.

Optionally, the first indication information is carried by an access network device setup message or an access network device configuration update message.

Optionally, the first communication module 110 is further configured to:
receive first response information for the first indication information from the second access network device and/or the core network element.

Optionally, the first response information is further used for indicating a sensing capability of the second access network device and/or a sensing capability of the core network element.

Optionally, the first communication module 110 is further configured to:
receive second indication information from the second access network device and/or the core network element, and the second indication information is used for indicating a sensing capability of the second access network device and/or a sensing capability of the core network element.

Optionally, the second indication information is carried by an access network device setup message, an access network device configuration update message or a core network configuration update message.

Optionally, the first communication module 110 is further configured to:
transmit a second response message for the second indication information to the second access network device and/or the core network element.

Optionally, the second response message is further used for indicating the sensing capability of the first access network device.

The first access network device 100 of the embodiment of the present disclosure can realize the corresponding functions of the first access network device in the aforementioned method embodiments. The flows, functions, implementation manners and beneficial effects corresponding to each module (sub-module, unit or component, etc.) in the first access network device 100 can refer to the corresponding description in the aforementioned method embodiments, and will not be repeated herein.

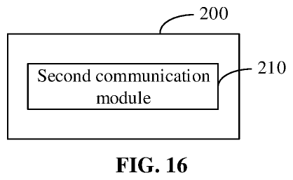

FIG. 16 is a schematic block diagram of an access network device 200 according to an embodiment of the present disclosure. The access network device 200 may include a second communication module 210.

The second communication module 210 is configured to receive third indication information from a core network element, and the third indication information is used for indicating a sensing capability of a first terminal and/or sensing grant information for the first terminal.

Optionally, the sensing grant information is used for indicating whether sensing of the first terminal is granted.

Optionally, the third indication information is carried by a terminal context.

Optionally, the core network element includes a mobility management network element.

The access network device 200 of the embodiment of the present disclosure can realize the corresponding functions of the access network device in the aforementioned method embodiments. The flows, functions, implementation manners and beneficial effects corresponding to each module (sub-module, unit or component, etc.) in the access network device 200 can refer to the corresponding description in the aforementioned method embodiments, and will not be repeated herein.

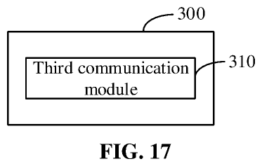

FIG. 17 is a schematic block diagram of a core network element 300 according to an embodiment of the present disclosure. The core network element 300 may include a third communication module 310.

The third communication module 310 is configured to transmit first indication information to an access network device, and the first indication information is used for indicating a sensing capability of the core network element.

Optionally, the first indication information is carried by a core network configuration update message.

Optionally, the third communication module 310 is further configured to:
receive first response information for the first indication information from the access network device.

Optionally, the first response information is further used for indicating a sensing capability of the access network device.

Optionally, the third communication module 310 is further configured to:
receive second indication information from the access network device, and the second indication information is used for indicating a sensing capability of the access network device.

Optionally, the third communication module 310 is further configured to:
transmit second response information for the second indication information to the access network device.

Optionally, the second response information is further used for indicating the sensing capability of the core network element.

The core network element 300 of the embodiment of the present disclosure can realize the corresponding functions of the core network element in the aforementioned method embodiments. The flows, functions, implementation manners and beneficial effects corresponding to each module (sub-module, unit or component, etc.) in the core network element 300 can refer to the corresponding description in the aforementioned method embodiments, and will not be repeated herein.

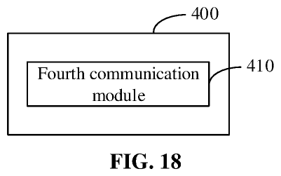

FIG. 18 is a schematic block diagram of a first core network element 400 according to an embodiment of the present disclosure. The first core network element 400 may include a fourth communication module 410.

The fourth communication module 410 is configured to receive first indication information from a first terminal and/or a second core network element, and the first indication information is used for indicating a sensing capability of the first terminal and/or sensing grant information for the first terminal.

Optionally, the first indication information from the first terminal is carried by a terminal registration request message.

Optionally, the second core network element includes a data management network element and/or a data storage network element.

Optionally, the fourth communication module 410 is further configured to:
transmit second indication information to an access network device and/or a third core network element, and the second indication information is used for indicating the sensing capability of the first terminal and/or the sensing grant information for the first terminal.

Optionally, the second indication information transmitted to the access network device is carried by a terminal context.

Optionally, the third core network element includes at least one of a sensing control network element, a data management network element or a data storage network element.

Optionally, the first core network element includes a mobility management network element.

Optionally, the first core network element includes a sensing control network element, and the second core network element includes at least one of a mobility management network element, a data management network element or a data storage network element.

The first core network element 400 of the embodiment of the present disclosure can realize the corresponding functions of the first core network element in the aforementioned method embodiments. The flows, functions, implementation manners and beneficial effects corresponding to each module (sub-module, unit or component, etc.) in the first core network element 400 can refer to the corresponding description in the aforementioned method embodiments, and will not be repeated herein.

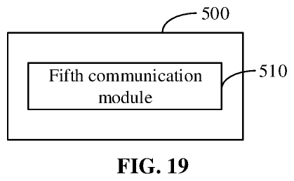

FIG. 19 is a schematic block diagram of a first terminal 500 according to an embodiment of the present disclosure. The first terminal 500 may include a fifth communication module 510.

The fifth communication module 510 is configured to transmit first indication information to a first core network element, and the first indication information is used for indicating a sensing capability of the first terminal and/or sensing grant information for the first terminal.

Optionally, the first indication information is carried by a terminal registration request message.

The first terminal 500 of the embodiment of the present disclosure can realize the corresponding functions of the first terminal in the aforementioned method embodiments. The flows, functions, implementation manners and beneficial effects corresponding to each module (sub-module, unit or component, etc.) in the first terminal 500 can refer to the corresponding description in the aforementioned method embodiments, and will not be repeated herein.

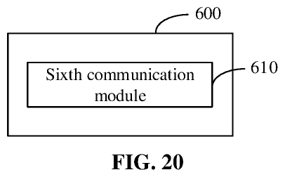

FIG. 20 is a schematic block diagram of a second core network element 600 according to an embodiment of the present disclosure. The second core network element 600 may include a sixth communication module 610.

The sixth communication module 610 is configured to transmit first indication information to a first core network element, and the first indication information is used for indicating sensing grant information for a first terminal.

Optionally, the sensing grant information is pre-stored in the second core network element.

Optionally, the first core network element includes a sensing control network element.

Optionally, the first core network element includes a mobility management network element.

Optionally, the sixth communication module 610 is further configured to:
receive second indication information from the mobility management network element, and the second indication information is used for indicating a sensing capability of a second terminal and/or sensing grant information for the second terminal.

Optionally, the second core network element includes a data management network element and/or a data storage network element.

The second core network element 600 of the embodiment of the present disclosure can realize the corresponding functions of the second core network element in the aforementioned method embodiments. The flows, functions, implementation manners and beneficial effect corresponding to each module (sub-module, unit or component, etc.) in the second core network element 600 can refer to the corresponding description in the aforementioned method embodiments, and will not be repeated herein.

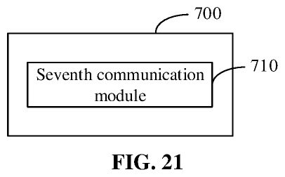

FIG. 21 is a schematic block diagram of first electronic equipment 700 according to an embodiment of the present disclosure. The first electronic equipment 700 may include a seventh communication module 710.

The seventh communication module 710 is configured to transmit first indication information to second electronic equipment, and the first indication information is used for indicating at least one of a sensing capability of the first electronic equipment, a sensing capability of a first terminal or sensing grant information for the first terminal.

Optionally, the sensing capability includes whether to support sensing and/or a sensing type supported.

Optionally, the sensing grant information is used for indicating whether sensing of the first terminal is granted.

Optionally, the first electronic equipment includes at least one of an access network device, a core network element or a terminal.

Optionally, the second electronic equipment includes at least one of an access network device or a core network element.

The first electronic equipment 700 of the embodiment of the present disclosure can realize the corresponding functions of the first electronic equipment in the aforementioned method embodiments. The flows, functions, implementation manners and beneficial effect corresponding to each module (sub-module, unit or component, etc.) in the first electronic equipment 700 can refer to the corresponding description in the aforementioned method embodiments, and will not be repeated herein.

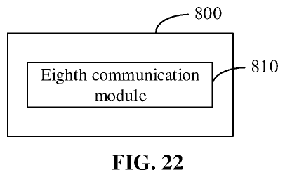

FIG. 22 is a schematic block diagram of second electronic equipment 800 according to an embodiment of the present disclosure. The second electronic equipment 800 may include an eighth communication module 810.

The eighth communication module 810 is configured to receive first indication information transmitted by first electronic equipment, and the first indication information is used for indicating at least one of a sensing capability of the first electronic equipment, a sensing capability of a first terminal or sensing grant information for the first terminal.

The second electronic equipment 800 of the embodiment of the present disclosure can realize the corresponding functions of the second electronic equipment in the aforementioned method embodiments. The flows, functions, implementation manners and beneficial effect corresponding to each module (sub-module, unit or component, etc.) in the second electronic equipment 800 can refer to the corresponding description in the aforementioned method embodiments, and will not be repeated herein.

It should be noted that the communication module in the embodiments of the present disclosure may be realized by a transceiver of the device, and part of or all of the other modules may be realized by a processor of the device.

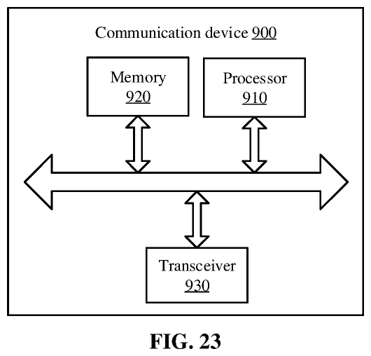

FIG. 23 is a schematic block diagram of a communication device 900 according to an embodiment of the present disclosure. The communication device 900 includes a processor 910, and the processor 910 can call and run a computer program from a memory to implement the method in the embodiments of the present disclosure.

Optionally, the communication device 900 may further include a memory 920. The processor 910 may call and run a computer program from the memory 920 to implement the method in the embodiments of the present disclosure.

The memory 920 may be a separate device independent of the processor 910 or may be integrated into the processor 910.

Optionally, the communication device 900 may further include a transceiver 930. The processor 910 may control the transceiver 930 to communicate with other devices. Specifically, the transceiver 930 may transmit information or data to other devices or receive information or data transmitted by other devices.

The transceiver 930 may include a transmitter and a receiver. The transceiver 930 may further include antennas, and the number of the antennas may be one or more.

Optionally, the communication device 900 may be the access network device, the core network element or the terminal of the embodiments of the present disclosure, or also may be the first electronic equipment or the second electronic equipment of the embodiments of the present disclosure, and the communication device 900 may implement corresponding processes implemented by the above devices in the various methods according to the embodiments of the present disclosure, which is not described repeatedly for the sake of simplicity.

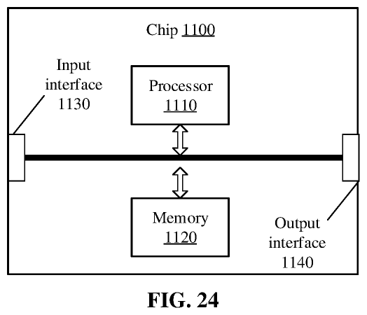

FIG. 24 is a schematic structural diagram of a chip 1100 according to an embodiment of the present disclosure. The chip 1100 includes a processor 1110. The processor 1110 can call and run computer programs from a memory to implement the method in the embodiments of the present disclosure.

Optionally, the chip 1100 may further include a memory 1120. The processor 1110 can call and run the computer program from the memory 1120 to implement the method in the embodiments of the present disclosure.

The memory 1120 maybe a separate device independent of the processor 1110 or may be integrated into the processor 1110.

Optionally, the chip 1100 may further include an input interface 1130. The processor 1110 may control the input interface 1130 to communicate with other devices or chips, and in particular to obtain information or data sent by other devices or chips.

Optionally, the chip 1100 may further include an output interface 1140. The processor 1110 may control the output interface 1140 to communicate with other devices or chips, and in particular to output information or data to other devices or chips.

Optionally, the chip may be applied to the access network device, the core network element or the terminal in the embodiments of the present disclosure, or may also be applied to the first electronic equipment or the second electronic equipment of the embodiments of the present disclosure, and the chip may implement the corresponding processes implemented by the above devices in various methods according to the embodiments of the present disclosure, which is not described repeatedly for the sake of brevity.

It should be noted that the chip mentioned in the embodiments of the present disclosure may also be referred to as a system level chip, a system chip, a chip system or an on-chip system chip, etc.

The above processor may be a general purpose processor, a digital signal processor (DSPS), an application specific integrated circuit (ASIC), a field programmable gate array (FPGA) or other programmable logic devices, discrete gates or transistor logic devices, and discrete hardware components. The above general purpose processor may be a microprocessor or the processor may be any conventional processor or the like.

The memory in the embodiments of the present disclosure may be a volatile memory or a non-volatile memory, or may include both a volatile and a non-volatile memory.

The non-volatile memory can be a read-only memory (ROM), a programmable ROM (PROM), an erasable PROM (EPROM), an electrically EPROM (EEPROM) or a flash memory. The volatile memory can be a random access memory (RAM).

It should be noted that the memory described above is exemplary, but not limiting. For example, the memory in the embodiments of the present disclosure may also be a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM) and a Direct Rambus RAM (DR RAM), etc. It is to be noted that the memory in the embodiments of the present disclosure is intended to include, but is not limited to, memories of these and any other suitable type.

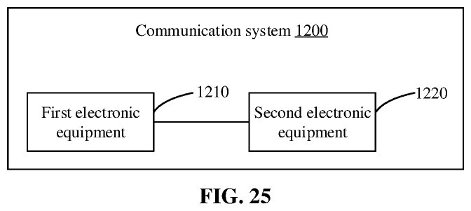

FIG. 25 is a schematic block diagram of a communication system 1200 according to an embodiment of the present disclosure. The communication system 1200 includes first electronic equipment 1210 and second electronic equipment 1220.

The first electronic equipment 1210 transmits first indication information to the second electronic equipment 1220, and the first indication information is used for indicating at least one of a sensing capability of the first electronic equipment 1210, a sensing capability of a first terminal or sensing grant information for the first terminal.

The second electronic equipment 1220 receives the first indication information transmitted by the first electronic equipment 1210.

The first electronic equipment 1210 maybe used to implement corresponding functions implemented by the first electronic equipment in the methods of the embodiments of the present disclosure, and the second electronic equipment 1220 maybe used to implement corresponding functions implemented by the second electronic equipment in the methods of the embodiments of the present disclosure, which is not described repeatedly for the sake of brevity.

In the above embodiments, it may be implemented in whole or in part by software, hardware, firmware or any combination thereof. When implemented by software, it can be implemented in whole or in part in the form of a computer program product. The computer program product includes one or more computer instructions. When the computer program instructions are loaded and executed on a computer, the processes or functions described in accordance with the embodiments of the present disclosure is generated in whole or in part. The computer may be a general purpose computer, a specific computer, a computer network, or other programmable devices. The computer instructions may be stored in a computer-readable storage medium or transmitted from one computer-readable storage medium to another computer-readable storage medium. For example, the computer instructions may be transmitted from one Web site, computer, server, or data center via wired (e.g. coaxial cable, optical fiber, Digital Subscriber Line (DSL)) or wireless (e.g. infrared, wireless, microwave, etc.) to another Web site, computer, server, or data center. The computer-readable storage medium may be any available medium accessible to a computer or a data storage device, such as a server containing one or more usable media integration, data center, etc. The available medium may be a magnetic medium (e.g. floppy disk, hard disk, magnetic tape), an optical medium (e.g. DVD), or a semiconductor medium (e.g. Solid State Disk (SSD)), etc.

It should be understood that in various embodiments of the present disclosure, the size of the sequence numbers of the above-mentioned processes does not mean an execution order, and the execution order of each process should be determined by its function and inherent logic, and should not be limited in any way to the implementation process of the embodiments of the present disclosure.

Those skilled in the art will clearly appreciate that, for convenience and conciseness of description, the specific operating processes of the above-described systems, devices and units may refer to the corresponding processes in the aforementioned embodiments corresponding to the methods and will not be elaborated herein.

The above is only the specific embodiments of the present disclosure, but the scope of protection of the present disclosure is not limited to this. Any modifications and variations that can be easily known by the person skilled in the art within the scope of protection of the present disclosure shall be covered in the scope of protection of the present disclosure. Therefore, the scope of protection of the present disclosure shall be subject to the scope of protection of the claims.

1. A first access network device, comprising:
a transceiver, configured to transmit first indication information to a core network element, wherein the first indication information is used for indicating a sensing capability of the first access network device.

2. The first access network device of claim 1, wherein the sensing capability comprises at least one of: whether to support sensing, or a sensing type supported.

3. The first access network device of claim 1, wherein the first indication information is carried by an access network device setup message or an access network device configuration update message.

4. The first access network device of claim 1, wherein the transceiver is further configured to:
receive first response information for the first indication information from the core network element.

5. The first access network device of claim 4, wherein the first response information is further used for indicating a sensing capability of the core network element.

6. The first access network device of claim 1, wherein the transceiver is further configured to:
receive second indication information from the core network element, wherein the second indication information is used for indicating a sensing capability of the core network element.

7. The first access network device of claim 6, wherein the second indication information is carried by a core network configuration update message.

8. The first access network device of claim 6, wherein the transceiver is further configured to:
transmit a second response message for the second indication information to the core network element.

9. The first access network device of claim 8, wherein the second response message is further used for indicating the sensing capability of the first access network device.

10. A core network element, comprising:
a transceiver, configured to transmit first indication information to an access network device, wherein the first indication information is used for indicating a sensing capability of the core network element.

11. The core network element of claim 10, wherein the first indication information is carried by a core network configuration update message.

12. The core network element of claim 10, wherein the transceiver is further configured to:
receive first response information for the first indication information from the access network device.

13. The core network element of claim 12, wherein the first response information is further used for indicating a sensing capability of the access network device.

14. The core network element of claim 13, wherein the sensing capability comprises at least one of: whether to support sensing, or a sensing type supported.

15. The core network element of claim 10, wherein the transceiver is further configured to:
receive second indication information from the access network device, wherein the second indication information is used for indicating a sensing capability of the access network device.

16. The core network element of claim 15, wherein the second indication information is carried by an access network device setup message or an access network device configuration update message.

17. The core network element of claim 16, wherein the transceiver is further configured to:
transmit second response information for the second indication information to the access network device.

18. The core network element of claim 17, wherein the second response information is further used for indicating the sensing capability of the core network element.

19. A first terminal, comprising:
a transceiver, configured to transmit first indication information to a first core network element, wherein the first indication information is used for indicating at least one of a sensing capability of the first terminal or sensing grant information for the first terminal.

20. The first terminal of claim 19, wherein the first indication information is carried by a terminal registration request message.
